(19) United States
(12) Patent Application Publication
(10) Pub. No.: US 2026/0082436 A1
(43) Pub. Date: Mar. 19, 2026

(54) METHOD FOR RECEIVING AND GENERATING SESSION IDENTIFIER OF SIDELINK POSITIONING SESSION, AND TERMINAL DEVICE

(71) Applicant: GUANGDONG OPPO MOBILE TELECOMMUNICATIONS CORP., LTD., Dongguan (CN)

(72) Inventors: Yang LIU, Dongguan (CN); Xinlei YU, Dongguan (CN)

(21) Appl. No.: 19/399,570

(22) Filed: Nov. 24, 2025

Related U.S. Application Data
(63) Continuation of application No. PCT/CN2023/119595, filed on Sep. 19, 2023.

(51) Int. Cl. H04W 76/11

(52) U.S. Cl. CPC H04W 76/11

(57) ABSTRACT

Provided are a method for receiving and generating a session identifier (ID) of a sidelink (SL) positioning session, and a terminal device. The method for receiving a session ID of an SL positioning session is performed by a receiver node and the method includes: receiving a first SL positioning protocol (SLPP) message, wherein the first SLPP message carries a first session ID; and transmitting a first message in a case where the first session ID is identical to any stored session ID, wherein the first message is used to request or direct a change to the first session ID; wherein the first session ID is used to identify a first positioning session to which the first SLPP message belongs.

### CROSS-REFERENCE TO RELATED APPLICATION

This application is a continuation of International Application No. PCT/CN2023/119595, filed Sep. 19, 2023, the entire disclosure of which is incorporated herein by reference.

### TECHNICAL FIELD

The present disclosure relates to the field of communications, and in particular, relates to a method for receiving and generating a session identifier (ID) of a sidelink (SL) positioning session, and a terminal device.

### RELATED ART

A terminal-to-terminal communication may be achieved over an SL, enabling a terminal device to engage in positioning interactions with another terminal device based on the SL communication, such that positioning information of the terminal device is determined.

In the related art, a terminal device may receive a positioning service request from another terminal device or an application layer. Upon receiving the positioning service request, the terminal device initiates an SL positioning session. Outside the coverage of a radio access network (RAN), positioning operations may rely on the interactions between terminal devices.

### SUMMARY

Embodiments of the present disclosure provide a method for receiving and generating a session ID of an SL positioning session, and a terminal device. The technical solutions are as follows.

According to some embodiments of the present disclosure, a method for receiving a session ID of an SL positioning session is provided. The method is performed by a receiver node, and includes: receiving a first SL positioning protocol (SLPP) message, wherein the first SLPP message carries a first session ID; and transmitting a first message in a case where the first session ID is identical to any stored session ID, wherein the first message is used to request or direct a change to the first session ID; wherein the first session ID is used to identify a first positioning session to which the first SLPP message belongs.

According to some embodiments of the present disclosure, a method for generating a session ID of an SL positioning session is provided. The method is performed by an initiator node, and includes: generating a third session ID for the SL positioning session, wherein the third session ID is associated with at least one of first information or second information; wherein the first information includes a unique ID of the initiator node, and the second information is distinctive information during initialization of different SL positioning sessions by the initiator node.

According to some embodiments of the present disclosure, a terminal device is provided. The terminal device includes a memory configured to store at least one computer program; and a processor configured to execute the at least one computer program to: receive a third SLPP message, wherein the third SLPP message carries a session ID of a second positioning session; and upon expiry of a second timer, release or invalidate the session ID of the second positioning session, or set the session ID of the second positioning session to an idle state; wherein a start time of the second timer is determined based on an end time of the second positioning session, or a start or reset time of the second timer is determined based on a reception time of the third SLPP message.

### BRIEF DESCRIPTION OF DRAWINGS

For clearer illustration of the technical solutions according to the embodiments of the present disclosure, the drawings required in the description of the embodiments are described hereinafter briefly. Obviously, the drawings described herein are only some of the embodiments of the present disclosure. A person of ordinary skill in the art may derive other drawings based on these drawings without any creative efforts.

FIG. 1 is a schematic diagram of an architecture of a communication system according to some embodiments of the present disclosure;

FIG. 2 is a schematic flowchart of a method for receiving a session ID of an SL positioning session according to some embodiments of the present disclosure;

FIG. 3 is a schematic flowchart of a method for transmitting a session ID of an SL positioning session according to some embodiments of the present disclosure;

FIG. 4 is a schematic interaction diagram of a method for changing a session ID of an SL positioning session according to some embodiments of the present disclosure;

FIG. 5 is a schematic interaction diagram of a method for changing a session ID of an SL positioning session according to some embodiments of the present disclosure;

FIG. 6 is a schematic interaction diagram of a method for changing a session ID of an SL positioning session according to some embodiments of the present disclosure;

FIG. 7 is a schematic flowchart of a method for generating a session ID of an SL positioning session according to some embodiments of the present disclosure;

FIG. 8 is a schematic flowchart of a method for generating a session ID of an SL positioning session according to some embodiments of the present disclosure;

FIG. 9 is a schematic flowchart of a method for generating a session ID of an SL positioning session according to some embodiments of the present disclosure;

FIG. 10 is a schematic flowchart of a method for receiving a session ID of an SL positioning session according to some embodiments of the present disclosure;

FIG. 11 is a schematic interaction diagram of a method for changing a session ID of an SL positioning session according to some embodiments of the present disclosure;

FIG. 12 is a structural block diagram of an apparatus for receiving a session ID of an SL positioning session according to some embodiments of the present disclosure;

FIG. 13 is a structural block diagram of an apparatus for transmitting a session ID of an SL positioning session according to some embodiments of the present disclosure;

FIG. 14 is a structural block diagram of an apparatus for generating a session ID of an SL positioning session according to some embodiments of the present disclosure;

FIG. 15 is a structural block diagram of an apparatus for receiving a session ID of an SL positioning session according to some embodiments of the present disclosure; and

FIG. 16 is a structural block diagram of a terminal device according to some embodiments of the present disclosure.

### DETAILED DESCRIPTION

For clearer descriptions of the objectives, technical solutions, and advantages of the present disclosure, some embodiments of the present disclosure are described in detail hereinafter with reference to the accompanying drawings. The exemplary embodiments are described in detail herein, and their examples are illustrated in the accompanying drawings. When the following description refers to the accompanying drawings, the same numerals in different accompanying drawings represent the same or similar elements, unless otherwise indicated. The embodiments described in the following exemplary embodiments do not represent all embodiments consistent with the present disclosure. Rather, these embodiments are merely examples of devices and methods consistent with some aspects of the present disclosure, as detailed in the appended claims.

The terms used in the present disclosure are solely for the purpose of describing specific embodiments and are not intended to limit the present disclosure. As used in the present disclosure and the appended claims, the singular forms “a,” “an,” and “the” are also intended to include their plural forms, unless the context clearly indicates otherwise. It should also be understood that the term “and/or” as used herein refers to and encompasses any or all possible combinations of one or more of associated listed items.

It should be understood that although the terms “first,” “second,” “third,” and the like may be used in the present disclosure to describe various types of information, and such information should not be limited by these terms. These terms are only used to distinguish one type of information from another. For example, first information may also be referred to as second information, and similarly, second information may also be referred to as first information, without departing from the scope of the present disclosure. The phrase “in a case where,” as used herein, may be interpreted as “when,” “upon,” or “in response to determining that,”depending on the context.

It should be understood that in various embodiments of the present disclosure, the size of the numerical order of processes does not imply the sequence of execution. The execution order of these processes should be determined based on their functions and inherent logic, and should not impose any restrictions on implementation processes of the embodiments in the present disclosure.

Prior to describing the technical solutions of the present disclosure, some background technical knowledge related to the present disclosure is first introduced and explained. The following related technologies, as optional solutions, may be arbitrarily combined with the technical solutions according to the embodiments of the present disclosure, and all such combinations fall within the protection scope of the embodiments of the present disclosure. The embodiments of the present disclosure include at least part of the following content.

A UE, i.e., user equipment, is also referred to as a terminal device.

An initiator terminal, i.e., initiator UE, refers to a terminal device that initiates a SL positioning service.

A target terminal, i.e., target UE, refers to a UE that has SL positioning requirements. Location information of the target UE needs to be determined in an SL positioning session.

An anchor terminal, i.e., anchor UE, refers a reference device for measurement in an SL positioning session. The anchor terminal may be a terminal device with a known location and is used to provide reference information for calculating a location of the target UE.

A server terminal, i.e., server UE, refers to a UE on a server used to provide SL positioning services. The server terminal may participate in a plurality of SL positioning sessions simultaneously and receive a measurement result from an anchor UE via the SLPP protocol to provide location information.

An initiator node refers to a terminal device that initiates an SL positioning session and is responsible for transmitting SL positioning-related messages or requests to other terminal devices. In some embodiments, the initiator node may be equivalently understood as the initiator terminal.

A receiver node refers to a terminal device that receives SL positioning-related messages or requests from an initiator node and is responsible for receiving and processing the SL positioning-related messages or requests from the initiator node. In some embodiments, the receiver node may be at least one of the anchor terminal, the target terminal, or the server terminal.

In the related art, a terminal-to-terminal communication may be achieved over an SL, enabling a terminal device to interact with another terminal device for SL positioning based on the SL communication, such that SL positioning information of the terminal device is determined. For example, in a case where UEs in a group communicate based on SLs, these UEs may use SL positioning reference signals (PRSs) to estimate locations of the UEs. This may include estimating either an absolute location (e.g., estimation of a latitude/longitude location) within a global coordinate system, or a relative location (e.g., a range or displacement of a UE relative to one or more other UEs). The UEs communicating via SLs may be within or outside a coverage of a cellular network. However, in scenarios outside the coverage, conventional SL positioning methods based on communication with servers in the cellular network may not be feasible. Therefore, locations of UEs relative to each other may be used to detect a location of a target UE.

A method for detecting the location of the target UE using the locations of UEs relative to each other is described hereinafter.

In step 1, the target UE may receive a ranging/SL positioning service request from the following sources:
a. A ranging/SL positioning service request over a proximity communication (PC5) interface. For an absolute location, the service request includes user information of the target UE and required positioning quality of service (QoS). For a relative location or ranging information, the service request includes the user information of the target UE, user information of one or more anchor UEs, and ranging/SL positioning QoS information.
b. A ranging/SL positioning service request from an application layer. The service request includes a type of a result (i.e., the absolute location, the relative location, or the ranging information) and required QoS.

In step 2, the target UE discovers the one or more anchor UEs (i.e., one or more SL reference UEs/located UEs).

In step 3, a UE-only operation is determined.

In a case where none of the target UE and the one or more anchor UEs are served by a next generation (NG)-RAN, or a serving network does not support ranging/SL positioning, the UE-only operation is applied, i.e., the locations of UEs relative to each other are used to detect the location of the target UE.

In step 4, the target UE and the one or more anchor UEs perform capability exchange.

Step 4 may be performed during step 5 and step 6 with coordination of a server UE.

In step 5, discovery and selection of the server UE is performed.

In a case where the target UE does not support SL positioning server functionalities, a server UE (either co-located with an anchor UE or operated by a separate UE) is discovered (in a case where the server UE is not yet discovered in step 2). In a case where a server UE is co-located with an anchor UE or operated by a separate UE, the target UE discovers and selects the server UE, and requests the server UE to participate in ranging/SL positioning.

In step 6, SLPP assistance data is transmitted.

The SLPP assistance data is transmitted among the target UE, the one or more anchor UEs, and the server UE.

In step 7, SL-PRS measurement is performed between the target UE and the one or more anchor UEs, and may also be performed between the one or more anchor UEs and the server UE.

In step 8, SL-PRS measurement data is transmitted and result calculation is performed.

The SL-PRS measurement data is transmitted to the server UE, or is transmitted to the target UE in a case where the target UE supports server functionalities, for result calculation. Based on the type of the result received in step 1, the absolute location, the relative position, or the ranging information is calculated at the UE.

In step 9, a ranging/SL positioning result is transmitted via the PC5 interface.

From the above steps, it may be seen that:
1) The UE initiates a positioning session upon receiving a location service (LCS) request.
2) A positioning session is set up for a particular LCS request corresponding to a particular positioning QoS requirement.
3) A UE, regardless of an anchor UE, a target UE, or a server UE, may be in a plurality of positioning sessions simultaneously.
4) The UE should have a way to differentiate messages for different ongoing positioning sessions. For example, the server UE receives a SL-PRS measurement result from an anchor UE via an SLPP ProvideLocationInformation message. In a case where the anchor UE takes the task of performing the SL-PRS measurement for two positioning sessions for the server UE, the server UE needs to know which LCS service request/SL positioning session/target UE the ProvideLocationInformation message corresponds to.

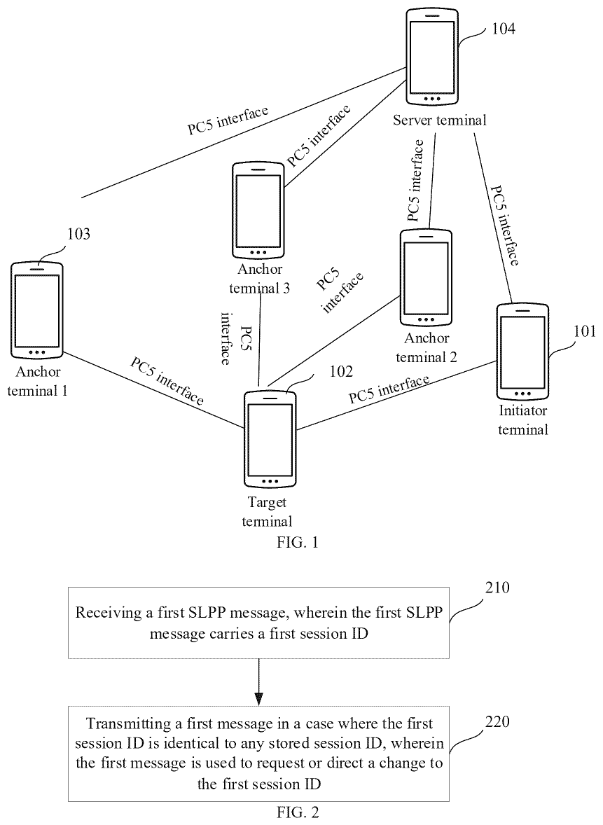

FIG. 1 is a schematic diagram of an architecture of a communication system according to some exemplary embodiments of the present disclosure. The number and form of terminal devices illustrated in FIG. 1 are only for illustration and do not limit the embodiments of the present disclosure. In practical applications, the system may include two or more terminal devices and two or more SL positioning assistance devices. The communication system illustrated in FIG. 1 by using an example where the system includes one target terminal, three anchor terminals, and one server terminal.

It should be noted that the technical solutions according to the embodiments of the present disclosure may be applied to various communication systems, such as a long-term evolution (LTE) system, a 5^{th} generation (5G) mobile communication system, a 5G new radio (NR) system, or other future new mobile communication systems.

The target terminal, the anchor terminal, and the server terminal in the embodiments of the present disclosure are all terminal devices, which are user-specific entities for receiving or transmitting signals. The terminal device may also be referred to a UE, a mobile station (MS), a mobile terminal (MT), or the like. The terminal device may be a car with communication functions, a smart car, a mobile phone, a wearable device, a tablet computer (e.g., a Pad), a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technology adopted by the terminal device or the specific form of the terminal device.

In some embodiments, an initiator terminal is a receiver terminal that requests positioning, and a target terminal is a receiver terminal to be positioned. The initiator terminal and the target terminal may be the same terminal device. A terminal device that assists the target terminal in positioning, i.e., the one that transmits SL PRS, is referred to as a transmitter terminal. The transmitter terminal may be an anchor terminal or a server terminal. In some embodiments, the target terminal may also be an anchor terminal or a server terminal. The anchor terminal and the server terminal are only for the convenience of distinguishing terminal devices and do not limit the terminal devices. Any terminal device may serve as at least one of the anchor terminal or the server terminal in different communication scenarios, which is not limited in the present disclosure.

In some embodiments, the target terminal initiates an SL positioning session upon receiving an LCS request. The initiator terminal, the target terminal, the anchor terminal, and the server terminal may be in a plurality of SL positioning sessions simultaneously. In an SL positioning session, location information of the target terminal needs to be determined. The anchor terminal is a reference device used for measurement in the SL positioning session. The anchor terminal may be a terminal device with a known location and is used to provide reference information for calculating a location of the target terminal. The server terminal is a UE on a server used to provide positioning services. The server terminal may participate in a plurality of SL positioning sessions simultaneously and receive a measurement result from an anchor terminal via the SLPP protocol to provide location information. In a possible implementation, the initiator terminal, the target terminal, the anchor terminal, and the server terminal communicate with each other via the PC5 interface.

FIG. 2 is a schematic flowchart of a method for receiving a session ID of an SL positioning session according to some embodiments of the present disclosure. In a case where the method is performed by a receiver node, the method includes at least part of the following steps.

In step 210, the receiver node receives a first SLPP message, wherein the first SLPP message carries a first session ID.

The first SLPP message refers to a message that is used for transmitting and exchanging information and transmitted from an initiator node to the receiver node under the SLPP protocol to support execution of an SL positioning process.

In some embodiments, the first SLPP message is a leading message in an SL positioning session.

The first session ID is carried in the first SLPP message and used to identify the positioning session to which the message belongs.

Positioning sessions refer to a series of interaction and communication processes between different nodes during the SL positioning process.

In some embodiments, the initiator node transmits the first SLPP message carrying the first session ID to the receiver node. The receiver node compares the received first session ID with any stored session ID to detect whether a collision occurs. The collision refers to a situation where the first session ID is identical to any stored session ID.

In some embodiments, any stored session ID refers to a session ID of an SL positioning session that has been stored in the receiver node. In SL positioning sessions, each SL positioning session is assigned a unique session ID to distinguish different SL positioning sessions. Each time the initiator node transmits an SLPP message to the receiver node, the receiver node stores a session ID of this SLPP message to identify a corresponding SL positioning session.

In step 220, the receiver node transmits a first message in a case where the first session ID is identical to any stored session ID, wherein the first message is used to request or direct a change to the first session ID.

Herein, the first session ID is used to identify a first positioning session to which the first SLPP message belongs.

In some embodiments, the first message is transmitted in a case where the first session ID is identical to any stored session ID in the receiver node.

In some embodiments, the first message is used to request or direct a change to the first session ID in a case where the first session ID is identical to any stored session ID, such that a conflict with any stored session ID is avoided.

In some embodiments, the first message indicates to change the first session ID. The indication may be implemented via transmission of at least one of session control information (SCI) or an SLPP message from the receiver node to the initiator node. For example, the SCI is a message format used to control and manage communication services and to exchange control information for SL positioning sessions between a terminal device and a network. The receiver node may transmit, via the SCI, a request to change the session ID. For example, SLPP is a protocol used to transmit the control information for SL positioning sessions between a terminal device and a network. The receiver node may transmit, via the SLPP message, information including a session ID change indication, thereby requesting or directing the initiator node to change the first session ID.

It should be noted that the embodiments of the present disclosure do not limit the indication manner of the first message for changing the first session ID.

In view of the above, in the method according to the embodiments of the present disclosure, the initiator node transmits a first SLPP message carrying a first session ID to the receiver node. The receiver node detects whether the first session ID is identical to any stored session ID. In a case where the first session ID is identical to any stored session ID, the receiver node replies to the initiator node for an update of the first session ID. This interaction method between the initiator node and the receiver node solves the collision problem in SL positioning sessions.

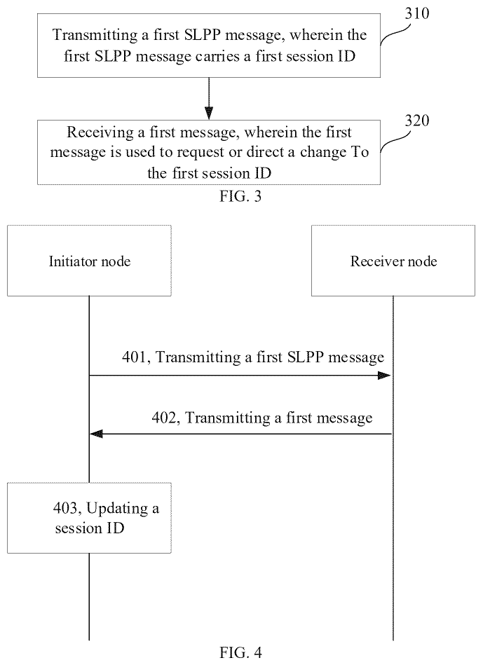

FIG. 3 is a schematic flowchart of a method for transmitting a session ID of an SL positioning session according to some embodiments of the present disclosure. In a case where the method is performed by an initiator node, the method includes at least part of the following steps.

In step 310, the initiator node transmits a first SLPP message, wherein the first SLPP message carries a first session ID.

In step 320, the initiator node receives a first message, wherein the first message is used to request or direct a change to the first session ID.

Herein, the first session ID is used to identify a first positioning session to which the first SLPP message belongs.

The first message includes an instruction from a receiver node for requesting or directing a change to the first session ID in a case where the first session ID transmitted by the initiator node is identical to any stored session ID in the receiver node.

In some embodiments, in a case where the first session ID from the initiator node is identical to any stored session ID in the receiver node, the initiator node receives the first message, wherein the first message is used to request or direct a change to the first session ID.

The initiator node is provided with two implementation manners to solve the problem of identical positioning session IDs. In different embodiments, the initiator node may adopt at least one of the two optional implementation manners.

### First Implementation Manner

FIG. 4 is a schematic interaction diagram of a method for changing a session ID of an SL positioning session according to some embodiments of the present disclosure. The method includes all or part of the following steps.

In step 401, an initiator node transmits a first SLPP message.

In some embodiments, the first SLPP message carries indication information, wherein the indication information is used to indicate that the first SLPP message is a leading message of a first positioning session, or an initial message of the first positioning session.

In some embodiments, during an SL positioning process, the first SLPP message carries indication information that may be used to identify the order of the SLPP message, to ensure the order and correctness of communication between different nodes.

In some embodiments, the indication information may be represented by at least one of a bit or a sequence number. For example, in a case where the indication information is represented by a bit, this bit may be set to 1 or 0, wherein a bit value of 1 indicates that the first SLPP message is the leading or initial message of the first positioning session; and a bit value of 0 indicates that the first SLPP message is not the leading or initial message of the first positioning session. Alternatively, in a case where the indication information is represented by a bit, this bit may be set to 1 or 0, wherein a bit value of 0 indicates that the first SLPP message is the leading or initial message of the first positioning session; and a bit value of 1 indicates that the first SLPP message is not the leading or initial message of the first positioning session.

In some embodiments, in a case where the indication information is represented by a sequence number, the first SLPP message may include a sequence number field used to indicate the order of the first SLPP message in the positioning session.

It should be noted that the embodiments of the present disclosure do not limit the representation manner of the indication information.

In step 402, a receiver node transmits a first message to the initiator node.

In some embodiments, in a case where the receiver node detects that the first session ID is identical to any stored session ID, the receiver node transmits the first message to the initiator node, wherein the first message is used to request or direct a change to the first session ID.

In step 403, the initiator node updates the first session ID.

In some embodiments, in response to receiving the first message, the initiator node updates the first session ID in the first SLPP message, wherein the updated session ID is different from the session ID prior to the update.

In some embodiments, the initiator node transmits a second SLPP message to the receiver node, wherein the second SLPP message carries a second session ID. The second session ID is a changed session ID for the first positioning session.

In some embodiments, the initiator node may update the session ID in a feedback update manner. For example, in a case where the initiator node adopts the feedback update manner, the initiator node may update the first session ID to the second session ID based on an instruction from the received first message. For example, in a case where the first message includes a new session ID (the second session ID), the initiator node may update the first session ID to the second session ID based on the new session ID in the feedback information. It should be noted that the above is only an illustrative description of the update manner adopted by the initiator node, and the embodiments of the present disclosure do not limit the update manner adopted by the initiator node.

In some embodiments, the second SLPP message carries indication information, wherein the indication information is used to indicate that the second SLPP message is the leading message of the first positioning session or the initial message of the first positioning session.

For the representation manner of the indication information, reference may be made to step 401, which is not elaborated herein.

### Second Implementation Manner

FIG. 5 is a schematic interaction diagram of a method for changing a session ID of an SL positioning session according to some embodiments of the present disclosure. The method includes all or part of the following steps.

In step 501, an initiator node transmits a first SLPP message.

In step 502, a receiver node transmits a first message to the initiator node.

In step 503, the initiator node removes the receiver node from a first positioning session.

In some embodiments, in response to receiving the first message, the initiator node removes the receiver node from the first positioning session, wherein the receiver node is a node that receives the first SLPP message and/or a node that transmits the first message. In some embodiments, the receiver node is an anchor terminal.

For example, the manner in which the initiator node removes the receiver node from the first positioning session may be terminating a connection. In some embodiments, in a case where the removal manner is terminating the connection, the initiator node may actively terminate a communication link with the receiver node to ensure that the receiver node is no longer able to participate in the current first positioning session. Alternatively, the initiator node may not terminate the communication link with the receiver node, with the communication link remaining active, but the initiator node no longer transmits SL positioning messages related to the first positioning session to the receiver node. In some embodiments, in a case where the receiver node has been removed by the initiator node from the first positioning session, the initiator node no longer transmits other messages in the first positioning session to the receiver node.

It should be noted that the above is only an illustrative description of the manner in which the initiator node removes the receiver node from the first positioning session, and the embodiments of the present disclosure do not limit the removal manner.

In view of the above, in the method according to the embodiments of the present disclosure, in a case where the initiator node receives, from the receiver node, a first message requesting to change a first session ID, the initiator node is provided with two options. The initiator node may choose a manner of updating the first session ID, or a manner of removing the receiver node from the first positioning session, to avoid any duplication between the first session ID and any stored session ID in the receiver node. Based on these two manners, the initiator node may manage and control SL positioning sessions and effectively solve the problem of identical session IDs.

It should be noted that the steps illustrated in FIG. 3 may be combined with the first implementation manner to form an embodiment, and the steps illustrated in FIG. 3 may also be combined with the second implementation manner to form an embodiment.

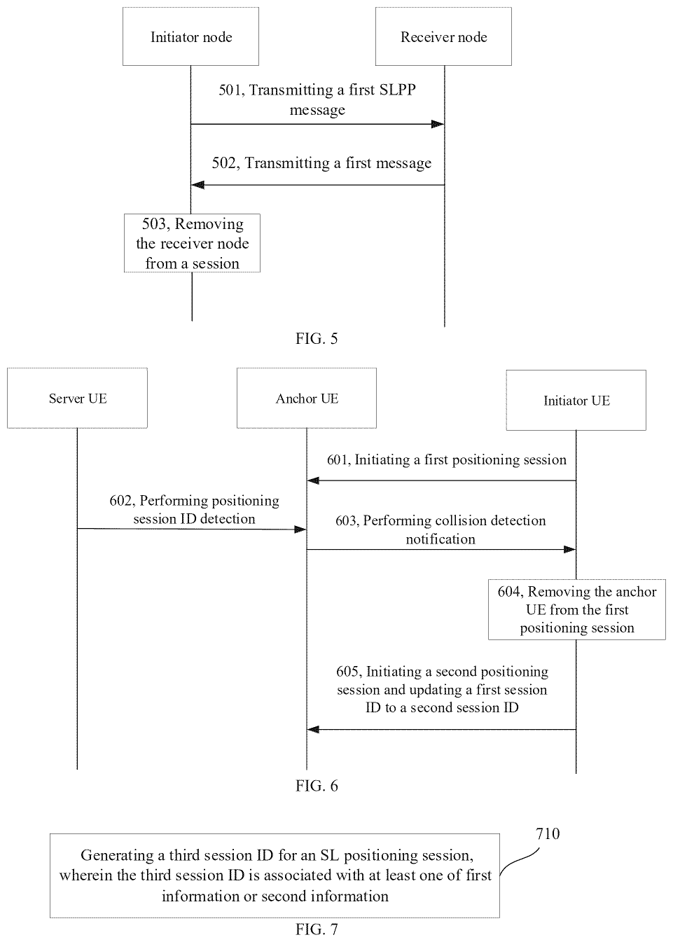

FIG. 6 is a schematic interaction diagram of a method for changing a session ID of an SL positioning session according to some embodiments of the present disclosure. In a case where the method is performed by an initiator UE, an anchor UE, and a server UE, the method includes at least part of the following steps.

In step 601, the initiator UE initiates a first positioning session.

The initiator UE refers to a terminal device that initiates a positioning request and transmits SL positioning-related messages or requests to other terminal devices.

In some embodiments, the initiator UE transmits a first SLPP message, wherein the first SLPP message carries a first session ID.

In step 602, the server UE performs positioning session ID detection.

In some embodiments, the server UE is a terminal device that receives and processes SL positioning requests and is capable of receiving messages from the initiator UE. In some embodiments, the anchor UE compares the first session ID from the initiator UE with any stored session ID in the server UE to determine whether the first session ID is identical to any stored session ID in the server UE.

In step 603, the anchor UE performs collision detection notification.

A collision refers to a situation where the first session ID is identical to any stored session ID in a receiver node.

In some embodiments, the anchor UE participates in collision detection notification in an SL positioning session during an SL positioning process to support the progress of the SL positioning session. In a case where the first session ID is identical to any stored session ID in the server UE, the anchor UE transmits a first message to the initiator UE. That is, the first message is transmitted in a case where the first session ID is identical to any stored session ID in the server UE.

In step 604, the initiator UE removes the anchor UE from the positioning session.

In some embodiments, the initiator UE removes the anchor UE from the first positioning session, which means that the initiator UE no longer regards the anchor UE as a participant in the first positioning session, and the anchor UE no longer participates in the SL positioning session.

In step 605, the initiator UE initiates a second positioning session and updates the first session ID to a second session ID.

In some embodiments, the initiator UE initiates a new SL positioning session and transmits a second SLPP message to the anchor UE, wherein the second SLPP message carries a second session ID, and the second session UD is changed from the first session ID.

In view of the above, in the method according to the embodiments of the present disclosure, the initiator UE initiates a first session request to the anchor UE. In a case where a conflict occurs between a first session ID from the initiator UE and any stored session ID in the server UE, the anchor UE transmits a collision detection notification to the initiator UE. The initiator UE may choose to remove the anchor UE from a first positioning session, or the initiator UE re-initiates an SL positioning session and updates the first session ID to a second session ID.

FIG. 7 is a schematic flowchart of a method for generating a session ID of an SL positioning session according to some embodiments of the present disclosure. The method includes all or part of the following steps.

In step 710, an initiator node generates a third session ID for an SL positioning session, wherein the third session ID is associated with at least one of first information or second information.

Herein, the first information includes a unique ID of the initiator node, and the second information is distinctive information during initialization of different SL positioning sessions by the initiator node.

The third session ID is used to identify an SL positioning session to which an SLPP message belongs. The generation of the third session ID requires combining or calculating at least one of the first information or the second information.

In some embodiments, the first information refers to a unique ID of the initiator node and is used to form part of a session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the initiator node.

For example, the initiator node is a terminal device, and the first information may refer to an international mobile equipment identity (IMEI) of the terminal device. The IMEI is a unique ID used to identify the terminal device.

In some embodiments, the second information refers to distinctive information during initialization of different SL positioning sessions by the initiator node.

In some embodiments, the second information includes the number of SL positioning sessions that have been used within the initiator node.

In some embodiments, the second information may include a timestamp. The timestamp varies each time an SL positioning session is initialized, resulting in different session IDs to distinguish different SL positioning sessions.

In some embodiments, the second information includes a maximum value of session IDs of the SL positioning sessions that have been used within the initiator node. In some embodiments, in a case where the second information includes the maximum value of the session IDs of the SL positioning sessions that have been used within the initiator node, the third session ID is determined based on a second value and the maximum value of the session IDs, wherein the second value is a positive integer. In some embodiments, the third session ID is the sum of the second value and the maximum value of the session IDs. In some embodiments, a session ID having a first maximum value of an SL positioning session that has been used within the initiator node incorporate the first information and the second information, wherein the second information includes a second maximum value preceding this SL positioning session. In some embodiments, the maximum value of the session IDs of the SL positioning sessions that have been used within the initiator node is acquired by incrementally accumulating from an initial value, wherein the initial value may be 1 or other possible values.

In view of the above, in the method according to the embodiments of the present disclosure, the session ID of the SL positioning session is formed by at least one of a unique ID of the initiator node or distinctive information during initialization of different SL positioning sessions by the initiator node. By setting the session ID of the SL positioning session to be unique, the problem of identical session IDs in SL positioning sessions is avoided.

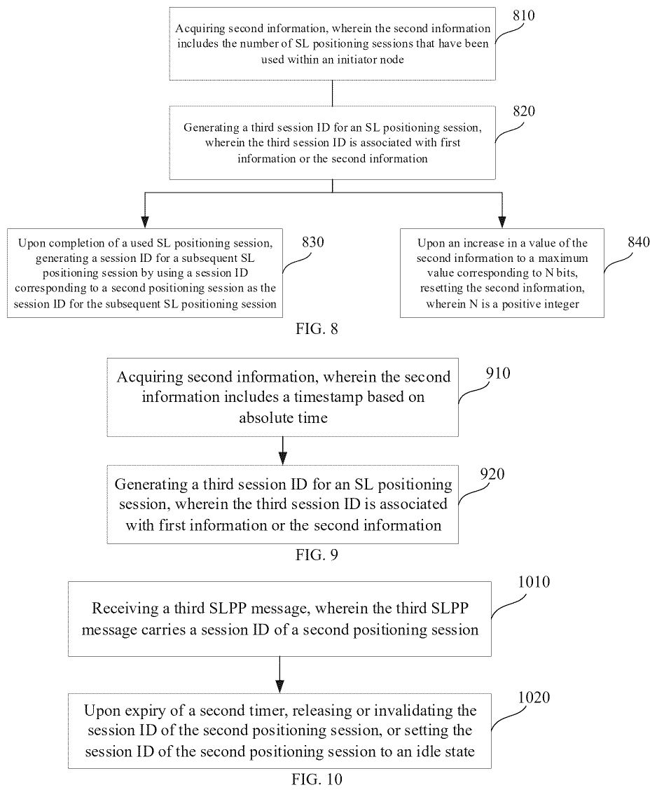

FIG. 8 is a schematic flowchart of a method for generating a session ID of an SL positioning session according to some embodiments of the present disclosure. The method includes all or part of the following steps.

In step 810, an initiator node acquires second information, wherein the second information includes the number of SL positioning sessions that have been used within an initiator node.

In some embodiments, the second information includes the number of SL positioning sessions that have been used within the initiator node. In some embodiments, each time an SL positioning session is initialized, the number of SL positioning sessions increases by 1. For example, the initiator node is a terminal device, and a counter may be employed within the terminal device to record the second information using the counter. Initially, the counter is set to 0. Upon the first initialization of an SL positioning session, the counter increases to 1. Upon the second initialization of an SL positioning session, the counter increases again to 2, and so on. Each time an SL positioning session is initialized, the counter increases by 1. It should be noted that the second information requires to be updated upon completion of the above steps.

In step 820, the initiator node generates a third session ID for an SL positioning session, wherein the third session ID is associated with first information and the second information.

Herein, the first information includes a unique ID of an initiator node.

In some embodiments, the first information refers to a unique ID of the initiator node and is used to form part of the session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the initiator node.

For example, the initiator node is a terminal device, and the first information may refer to an IMEI of the terminal device. The IMEI is a unique ID used to identify the terminal device.

In some embodiments, the third session ID is acquired by concatenating the first information and the second information.

Concatenation refers to a process or operation of connecting two or more objects or information elements together to form a whole. In some embodiments, concatenation refers to combining the first information with the second information to form a session ID.

For example, the first information and the second information may be concatenated together via a string to form a new string as the third session ID of the SL positioning session. In some embodiments, the third session ID may be generated by at least one of: concatenating the first information with the second information, or concatenating the second information with the first information.

In some embodiments, the third session ID is acquired by concatenating the first information and third information, wherein the third information is determined based on the second information and a first value, and the first value is a positive integer. In some embodiments, a value of the third information is equal to the sum of the first value and a value of the second information.

In some embodiments, the third information is acquired by adding the first value to the value of the second information, and the third session ID is acquired by concatenating the third information and the first information. The first value may be any positive integer. In an example, the first value is 2. In another example, the first value is 1. For example, the first information is ‘111,’ the first value is 1, an initial value of the second information is 1, and session IDs of 6 used SL positioning sessions are ‘1111,’ ‘1112,’ ‘1113,’ ‘1114,’ ‘1115,’ and ‘1116.’ Even in a case where one or more SL positioning sessions end (e.g., the SL positioning session corresponding to ‘1115’ ends), a session ID of a subsequent SL positioning session is ‘1117.’ That is, the session ID of the ended SL positioning session is no longer used.

In some embodiments, the third session ID may be generated by at least one of: concatenating the first information with the third information, or concatenating the third information with the first information.

In other embodiments, the session ID of the ended SL positioning session may also be reused, as described in the following steps.

In step 830, upon completion of a second positioning session of initialized SL positioning sessions, the initiator node generates a session ID for a subsequent SL positioning session by using a session ID corresponding to the second positioning session as the session ID for the subsequent SL positioning session.

In some embodiments, in SL positioning sessions, the second information includes the number of used SL positioning sessions, and a communication system assigns a session ID to the initiator node based on the number of used SL positioning sessions. In a case where an initialized second positioning session ends, a session ID of the second positioning session becomes idle. In some embodiments, the session ID in the idle state may be reassigned to another subsequent SL positioning session for use.

Two manners are provided for a receiver node to explicitly determine that the session ID of the second positioning session has become idle. At least one of these two manners may be employed.

### Manner 1

Upon completion of the second positioning session of initialized SL positioning sessions, the initiator node transmits a notification message to the receiver node, wherein the notification message is used to notify a release of the second positioning session, or a release, invalidation, or idleness of the session ID of the second positioning session.

### Manner 2

In some embodiments, a first timer is set within the initiator node. A start time of the first timer is determined based on an end time of the second positioning session. Alternatively, a start or reset time of the first timer is determined based on a transmission time of a last message of the second positioning session. Upon expiry of the first timer, the session ID of the second positioning session is used to generate a session ID of a subsequent SL positioning session. In some embodiments, a timing duration of the timer may be predefined by a communication protocol, preconfigured by a network device, or determined by negotiation between terminal devices. For example, the timing duration of the timer is 0.5 ms.

It should be noted that, to enable the receiver node to explicitly determine that the session ID of the second positioning session has become idle, in a possible implementation, manner 1 and manner 2 may be executed simultaneously. Alternatively, manner 1 or manner 2 may be executed alone.

In some embodiments, in a case where the session ID corresponding to the second positioning session is used as a session ID for the subsequent SL positioning session, the count of the number of used SL positioning sessions is suspended from increasing.

In some embodiments, in a case where a duration for which the session ID of the second positioning session is in the idle state reaches a first duration, the session ID corresponding to the second positioning session is used as the session ID of the subsequent SL positioning session, wherein the first duration is the timing duration of the first timer.

In step 840, upon an increase in a value of the second information to a maximum value corresponding to N bits, the initiator node resets the second information, wherein N is a positive integer.

The second information includes the number of used SL positioning sessions.

In some embodiments, the second information is represented by N bits. Upon an increase in a value of the second information to the maximum value represented by N bits, the second information may be reset and an accumulation process may restart. This approach may keep the value of the second information within a reasonable range. In some embodiments, in a case where the second information is reset, session IDs in SL positioning sessions also require to be reset.

For example, an 8-bit binary number is used to represent the second information. Initially, the value of the second information is 0. Each time the initiator node initializes a new SL positioning session, the value of the second information increases by 1. In a case where the second information increases to ‘11111111,’ i.e., reaching the maximum value 255 represented by 8 bits, the value of the second information is reset to 0 and the accumulation process restarts. The same 8 bits may be used cyclically to represent the number of SL positioning sessions, ensuring that the value of the second information is within a controllable range to guarantee data accuracy.

In view of the above, in the method according to the embodiments of the present disclosure, in a case where the second information includes the number of SL positioning sessions that have been used within the initiator node, a timer may be set in the receiver node to indicate the end of the SL positioning session; or, upon an increase in a value of the second information to the maximum value corresponding to N bits, the second information is reset. This approach maintains the value of the second information within a reasonable range.

It should be noted that the above steps 810 and 820 may be implemented as a new embodiment. Steps 810, 820, and 830 may implemented as a new embodiment. Steps 810, 820, and 840 may be implemented as a new embodiment.

FIG. 9 is a schematic flowchart of a method for generating a session ID of an SL positioning session according to some embodiments of the present disclosure. The method includes all or part of the following steps.

In step 910, an initiator node acquires second information, wherein the second information includes a timestamp based on absolute time.

In some embodiments, the second information includes a timestamp based on absolute time. The granularity of the timestamp may be predefined by a communication protocol, preconfigured by a network device, or determined by negotiation between terminals. For example, the timestamp is a second-level timestamp or a microsecond-level timestamp.

For example, the initiator node is a terminal device, and each time an SL positioning session is initialized, the timestamp based on the current absolute time may be acquired as the second information. In different SL positioning sessions, the timestamp based on the absolute time varies each time an SL positioning session is initialized, resulting in different session IDs for the SL positioning sessions.

In step 920, the initiator node generates a third session ID for an SL positioning session, wherein the third session ID is associated with first information and the second information.

Herein, the first information includes a unique ID of the initiator node.

In some embodiments, the first information refers to a unique ID of the initiator node and is used to form part of the session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the initiator node.

For example, the initiator node is a terminal device, and the first information may refer to an IMEI of the terminal device. The IMEI is a unique ID used to identify a mobile phone.

In some embodiments, the third session ID is acquired by concatenating the first information and the second information.

Concatenation refers to a process or operation of connecting two or more objects or information elements together to form a whole. In some embodiments, concatenation refers to combining the first information with the second information to form a session ID.

For example, the first information and the second information may be concatenated together via a string to form a new string as the third session ID of the SL positioning session. In some embodiments, the third session ID may be generated by at least one of: concatenating the first information with the second information, or concatenating the second information with the first information.

In some embodiments, the third session ID is acquired by concatenating the first information and third information, wherein the third information is determined based on the second information and a first value, wherein the first value is a positive integer. In some embodiments, a value of the third information is equal to the sum of the first value and a value of the second information.

In some embodiments, the third information is acquired by adding the first value to the value of the second information, and the third session ID is acquired by concatenating the third information and the first information. The first value may be any positive integer. In an example, the first value is 2. In another example, the first value is 1. In some embodiments, the third session ID may be generated by at least one of: concatenating the first information with the third information, or concatenating the third information with the first information.

FIG. 10 is a schematic flowchart of a method for receiving a session ID of an SL positioning session according to some embodiments of the present disclosure. The method includes all or part of the following steps.

In step 1010, a receiver node receives a third SLPP message, wherein the third SLPP message carries a session ID of a second positioning session.

The third SLPP message refers to a message that is used for transmitting and exchanging information and transmitted from an initiator node to the receiver node under the SLPP protocol to support execution of an SL positioning process.

In some embodiments, the third SLPP message is a latest or last message in an SL positioning session.

In some embodiments, upon completion of a second positioning session in initialized SL positioning sessions, a session ID for a subsequent SL positioning session is generated by using a session ID corresponding to the second positioning session as the session ID for the subsequent SL positioning session. The initiator node transmits the third SLPP message to the receiver node, wherein the third SLPP message includes the session ID of the second positioning session that is released, invalidated, or set to an idle state.

In step 1020, upon expiry of a second timer, the receiver node releases or invalidates the session ID of the second positioning session, or sets the session ID of the second positioning session to an idle state.

Herein, a start time of the second timer is determined based on an end time of the second positioning session, or a start or reset time of the second timer is determined based on a reception time of the third SLPP message.

In some embodiments, the session ID of the second positioning session is associated with at least one of first information or second information, wherein the first information includes a unique ID of the initiator node, and the second information is distinctive information during initialization of different SL positioning sessions by the initiator node.

In some embodiments, the second timer associated with the second positioning session is set within the receiver node. In a case where the receiver node receives a notification message from the initiator node, wherein the notification message is used to indicate the end of the second positioning session, the start time of the second timer may be determined based on the end time of the second positioning session; or the start or reset time of the second timer is determined based on the reception time of the third SLPP message. The second timer is reset upon reception of messages related to the second positioning session. Upon reception of the notification message or expiry of the second timer, the second timer triggers the receiver node to set the session ID of the second positioning session to be invalid or idle. In some embodiments, a timing duration of the timer may be predefined by a communication protocol, preconfigured by a network device, or determined by negotiation between terminal devices. For example, the timing duration of the timer is 0.5 ms.

In view of the above, in the method according to the embodiments of the present disclosure, the receiver node receives a third SLPP message carrying a session ID of a second positioning session from the initiator node. Upon expiry of a second timer, the receiver node releases or invalidates the session ID of the second positioning session, or sets the session ID of the second positioning session to an idle state. This approach ensures that the receiver node is aware of the state of the session ID being released or idle, thereby improving the efficiency and accuracy of the communication system.

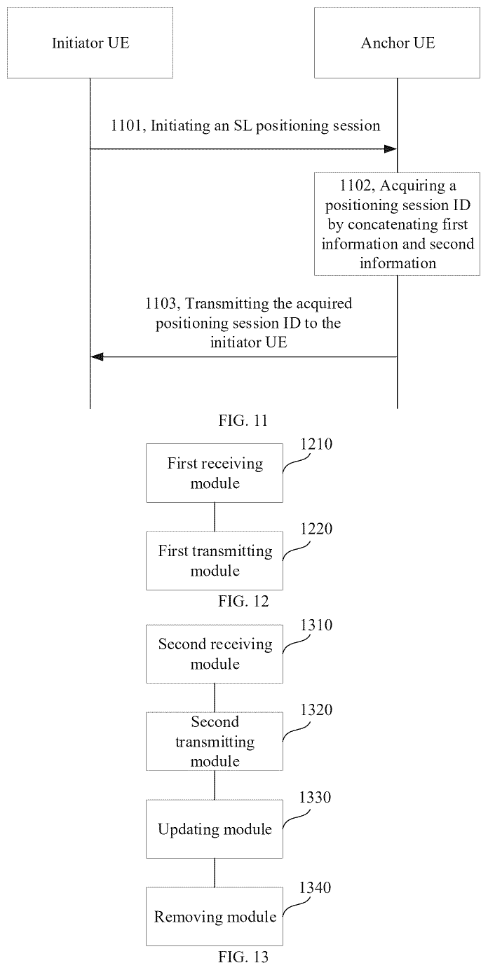

FIG. 11 is a schematic interaction diagram of a method for changing a session ID of an SL positioning session according to some embodiments of the present disclosure. In a case where the method is performed by an initiator UE and an anchor UE, the method includes at least part of the following steps.

In step 1101, the initiator UE initiates an SL positioning session.

The initiator UE refers to a terminal device that initiates a positioning request and transmits SL positioning-related messages or requests to the anchor UE.

The anchor UE refers to a terminal device serving as a reference device and is used to provide reference information to the initiator UE.

In some embodiments, the initiator UE initiates the SL positioning session by transmitting an SLPP message to the anchor UE, wherein the SLPP message carries a session ID used to identify the SL positioning session to which the SLPP message belongs.

In step 1102, the anchor UE acquires a session ID by concatenating first information and second information.

The first information includes a unique ID of the initiator node, and the second information is distinctive information during initialization of different SL positioning sessions by the initiator node. In some embodiments, the first information may include a unique ID of a terminal device, and the second information may include the number of SL positioning sessions that have been used within the initiator node or a timestamp based on absolute time.

In some embodiments, the anchor UE acquires a session ID by concatenating the first information and the second information, wherein the acquired session ID is unique.

In step 1103, the anchor UE transmits the acquired session ID to the initiator UE.

In some embodiments, the anchor UE transmits the acquired session ID to the initiator UE, and the initiator UE may associate the session ID with its own SL positioning request to ensure that the initiator UE correctly identifies and processes SL positioning sessions related to the initiator UE.

In view of the above, in the method according to the embodiments of the present disclosure, the initiator UE initiates an SL positioning session, and then the anchor UE acquires a session ID by concatenating first information and second information. Since the acquired session ID is unique, the problem of identical positioning IDs in SL positioning sessions is effectively avoided.

It should be noted that in a possible implementation, the steps illustrated in FIG. 4 may be combined with the steps shown in FIG. 9 to form a new embodiment, or the steps illustrated in FIG. 5 may be combined with the steps illustrated in FIG. 9 to form a new embodiment, or the steps illustrated in FIG. 6 may be combined with the steps illustrated in FIG. 9 to form a new embodiment, which is not elaborated herein.

The following are apparatus embodiments of the present disclosure, wherein the apparatus may be configured to execute the method embodiments of the present disclosure. For details not disclosed in the apparatus embodiments of the present disclosure, reference may be made to the method embodiments of the present disclosure.

FIG. 12 is a structural block diagram of an apparatus for receiving a session ID of an SL positioning session according to some embodiments of the present disclosure. The apparatus has a function of implementing the method for receiving a session ID of an SL positioning session as described above. The apparatus may include a first receiving module 1210 and a first transmitting module 1220.

The first receiving module 1210 is configured to receive a first SLPP message, wherein the first SLPP message carries a first session ID.

The first SLPP message refers to a message that is used for transmitting and exchanging information and received by the first receiving module 1210 from an initiator node under the SLPP protocol to support execution of an SL positioning process.

In some embodiments, the first SLPP message is a leading message in an SL positioning session.

The first session ID is carried in the first SLPP message and used to identify the positioning session to which the message belongs.

Positioning sessions refer to a series of interaction and communication processes between different nodes during the SL positioning process.

In some embodiments, the first receiving module 1210 receives the first SLPP message carrying the first session ID from the initiator node. The first receiving module 1210 compares the received first session ID with any stored session ID to detect whether a collision occurs. The collision refers to a situation where the first session ID is identical to any stored session ID.

In some embodiments, any stored session ID refers to a session ID of an SL positioning session that has been stored in the first receiving module 1210. In SL positioning sessions, each SL positioning session is assigned a unique session ID to distinguish different SL positioning sessions. Each time the initiator node transmits an SLPP message to the first receiving module 1210, the first receiving module 1210 stores a session ID of this SLPP message to identify a corresponding SL positioning session.

The first transmitting module 1220 is configured to transmit a first message in a case where the first session ID is identical to any stored session ID, wherein the first message is used to request or direct a change to the first session ID.

Herein, the first session ID is used to identify a first positioning session to which the first SLPP message belongs.

In some embodiments, the first message is transmitted in a case where the first session ID is identical to any stored session ID in the first receiving module 1210.

In some embodiments, the first message is used to request or direct a change to the first session ID in a case where the first session ID is identical to any stored session ID, such that a conflict with any stored session ID is avoided.

In some embodiments, the first message indicates to change the first session ID. The indication may be implemented via transmission of at least one of SCI or an SLPP message from the first transmitting module 1220 to the initiator node. For example, the SCI is a message format used to control and manage communication services and to exchange control information for SL positioning sessions between a terminal device and a network. The first transmitting module 1220 may transmit, via the SCI, a request to change the session ID. For example, SLPP is a protocol used to transmit the control information for SL positioning sessions between a terminal device and a network. The first transmitting module 1220 may transmit, via the SLPP message, information including a session ID change indication, thereby requesting or directing the initiator node to change the first session ID.

It should be noted that the embodiments of the present disclosure do not limit the indication manner of the first message for changing the first session ID.

In view of the above, in the apparatus according to the embodiments of the present disclosure, the first receiving module 1210 receives a first SLPP message carrying a first session ID from the initiator node. The first receiving module 1210 detects whether the first session ID is identical to any stored session ID. In a case where the first session ID is identical to any stored session ID, the first transmitting module 1220 replies to the initiator node for an update of the first session ID. This interaction method between the initiator node and the apparatus solves the collision problem in SL positioning sessions.

FIG. 13 is a structural block diagram of an apparatus for transmitting a session ID of an SL positioning session according to some embodiments of the present disclosure. The apparatus has a function of implementing the method for transmitting a session ID of an SL positioning session as described above. The apparatus may include: a second receiving module 1310, a second transmitting module 1320, an updating module 1330, and a removing module 1340.

The second transmitting module 1320 is configured to transmit a first SLPP message, wherein the first SLPP message carries a first session ID.

The second receiving module 1310 is configured to receive a first message, wherein the first message is used to request or direct a change to the first session ID.

Herein, the first session ID is used to identify a first positioning session to which the first SLPP message belongs.

In some embodiments, in a case where the first session ID is identical to any stored session ID in a receiver node, the receiver node transmits an instruction requesting or directing a change to the first session ID. In this case, the second receiving module 1310 receives the first message.

The first message is used to request or direct a change to the first session ID.

In some embodiments, the apparatus further includes the updating module 1330.

The updating module 1330 is configured to update the first session ID.

In some embodiments, in response to the second receiving module 1310 receiving the first message, the updating module 1330 updates the first session ID in the first SLPP message, wherein the updated session ID is different from the session ID prior to the update.

In some embodiments, the second transmitting module 1320 is further configured to transmit a second SLPP message to the receiver node, wherein the second SLPP message carries a second session ID. The second session ID is a changed session ID for the first positioning session.

In some embodiments, the updating module 1330 may update the session ID in a feedback update manner. For example, in a case where the apparatus adopts the feedback update manner, the second receiving module 1310 may update the first session ID to the second session ID based on an instruction from the received first message. For example, in a case where the first message includes a new session ID (the second session ID), the updating module 1330 may update the first session ID to the second session ID based on the new session ID in the feedback information. It should be noted that the above is only an illustrative description of the update manner adopted by the updating module 1330, and the embodiments of the present disclosure do not limit the update manner adopted by the updating module 1330.

In some embodiments, the second SLPP message carries indication information, wherein the indication information is used to indicate that the second SLPP message is the leading message of the first positioning session or the initial message of the first positioning session.

In some embodiments, the apparatus further includes the removing module 1340.

The removing module 1340 is configured to remove the receiver node from the first positioning session.

In some embodiments, in response to the second receiving module 1310 receiving the first message, the removing module 1340 removes the receiver node from the first positioning session, wherein the receiver node is a node that receives the first SLPP message and/or a node that transmits the first message. In some embodiments, the receiver node is an anchor terminal.

For example, the manner in which the removing module 1340 removes the receiver node from the first positioning session may be terminating a connection. In some embodiments, in a case where the removal manner is terminating the connection, the apparatus may actively terminate a communication link with the receiver node to ensure that the receiver node is no longer able to participate in the current first positioning session. Alternatively, the apparatus may not terminate the communication link with the receiver node, with the communication link remaining active, but the apparatus no longer transmits SL positioning messages related to the first positioning session to the receiver node. In some embodiments, in a case where the receiver node has been removed by the removing module 1340 from the first positioning session, the apparatus no longer transmits other messages in the first positioning session to the receiver node.

It should be noted that the above is only an illustrative description of the manner in which the removing module 1340 removes the receiver node from the first positioning session, and the embodiments of the present disclosure do not limit the removal manner.

In view of the above, in the apparatus according to the embodiments of the present disclosure, in a case where the second receiving module 1310 receives, from the receiver node, a first message requesting to change a first session ID, the apparatus is provided with two options. The updating module 1330 may choose a manner of updating the first session ID, or the removing module 1340 removes the receiver node from the first positioning session, to avoid any duplication between the first session ID and any stored session ID in the receiver node. Based on these two manners, the apparatus may manage and control SL positioning sessions and effectively solve the problem of identical session IDs.

It should be noted that the second transmitting module 1320, the second receiving module 1310, and the updating module 1330 may be implemented as an embodiment; the second transmitting module 1320, the second receiving module 1310, and the removing module 1340 may be implemented as an embodiment; or the second transmitting module 1320, the second receiving module 1310, the updating module 1330, and the removing module 1340 may be implemented as an embodiment, which is not elaborated herein.

FIG. 14 is a structural block diagram of an apparatus for generating a session ID of an SL positioning session according to some embodiments of the present disclosure. The apparatus has a function of implementing the method for generating a session ID of an SL positioning session as described above. The apparatus may include: a generating module 1410, an acquiring module 1420, a resetting module 1430, and a transmitting module 1440.

The generating module 1410 is configured to generate a third session ID for an SL positioning session, wherein the third session ID is associated with at least one of first information or second information.

Herein, the first information includes a unique ID of the apparatus, and the second information is distinctive information during initialization of different SL positioning sessions by the apparatus.

The third session ID is used to identify an SL positioning session to which an SLPP message belongs. The generation of the third session ID requires combining or calculating at least one of the first information or the second information.

In some embodiments, the first information refers to a unique ID of the apparatus and is used to form part of a session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the apparatus.

For example, the apparatus is a terminal device, and the first information may refer to an IMEI of the terminal device. The IMEI is a unique ID used to identify the terminal device.

In some embodiments, the second information refers to distinctive information during initialization of different SL positioning sessions by the apparatus.

In some embodiments, the second information includes the number of SL positioning sessions that have been used within the apparatus.

In some embodiments, the second information may include a timestamp. The timestamp varies each time an SL positioning session is initialized, resulting in different session IDs to distinguish different SL positioning sessions.

In some embodiments, the second information includes a maximum value of session IDs of the SL positioning sessions that have been used within the apparatus. In some embodiments, in a case where the second information includes the maximum value of the session IDs of the SL positioning sessions that have been used within the apparatus, the third session ID is determined based on a second value and the maximum value of the session IDs, wherein the second value is a positive integer. In some embodiments, the third session ID is the sum of the second value and the maximum value of the session IDs. In some embodiments, a session ID having a first maximum value of an SL positioning session that has been used within the apparatus incorporate the first information and the second information, wherein the second information includes a second maximum value preceding this SL positioning session. In some embodiments, the maximum value of the session IDs of the SL positioning sessions that have been used within the apparatus is acquired by incrementally accumulating from an initial value, wherein the initial value may be 1 or other possible values. In view of the above, in the apparatus according to the embodiments of the present disclosure, the session ID of the SL positioning session is formed by at least one of a unique ID of the apparatus or distinctive information during initialization of different SL positioning sessions by the apparatus. By setting the session ID of the SL positioning session to be unique, the problem of identical session IDs in SL positioning sessions is avoided.

In some embodiments, the apparatus further includes the acquiring module 1420.

The acquiring module 1420 is configured to acquire second information, wherein the second information includes the number of used SL positioning sessions.

In some embodiments, the second information includes the number of SL positioning sessions that have been used within the apparatus.

In some embodiments, each time an SL positioning session is initialized, the number of SL positioning sessions increases by 1. For example, the apparatus is a terminal device, and a counter may be employed within the terminal device to record the second information using the counter. Initially, the counter is set to 0. Upon the first initialization of an SL positioning session, the counter increases to 1. Upon the second initialization of an SL positioning session, the counter increases again to 2, and so on. Each time an SL positioning session is initialized, the counter increases by 1.

It should be noted that the second information requires to be updated upon completion of the above steps.

The generating module 1410 is configured to generate a third session ID for an SL positioning session, wherein the third session ID is associated with first information and the second information.

Herein, the first information includes a unique ID of the apparatus.

In some embodiments, the first information refers to a unique ID of the apparatus and is used to form part of the session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the apparatus.

For example, the apparatus is a terminal device, and the first information may refer to an IMEI of the terminal device. The IMEI is a unique ID used to identify the terminal device.

In some embodiments, the third session ID is acquired by concatenating the first information and the second information.

Concatenation refers to a process or operation of connecting two or more objects or information elements together to form a whole. In some embodiments, concatenation refers to combining the first information with the second information to form a session ID.

For example, the first information and the second information may be concatenated together via a string to form a new string as the third session ID of the SL positioning session.

In some embodiments, the third session ID may be generated by at least one of: concatenating the first information with the second information, or concatenating the second information with the first information.

In some embodiments, the third session ID is acquired by concatenating the first information and third information, wherein the third information is determined based on the second information and a first value, and the first value is a positive integer. In some embodiments, a value of the third information is equal to the sum of the first value and a value of the second information.

In some embodiments, the third information is acquired by adding the first value to the value of the second information, and the third session ID is acquired by concatenating the third information and the first information. The first value may be any positive integer. In an example, the first value is 2. In another example, the first value is 1. For example, the first information is ‘111,’ the first value is 1, an initial value of the second information is 1, and session IDs of 6 used SL positioning sessions are ‘1111,’ ‘1112,’ ‘1113,’ ‘1114,’ ‘1115,’ and ‘1116.’ Even in a case where one or more SL positioning sessions end (e.g., the SL positioning session corresponding to ‘1115’ ends), a session ID of a subsequent SL positioning session is ‘1117.’ That is, the session ID of the ended SL positioning session is no longer used. In some embodiments, the third session ID may be generated by at least one of: concatenating the first information with the third information, or concatenating the third information with the first information.

The generating module 1410 is configured to, upon completion of a second positioning session of initialized SL positioning sessions, generate a session ID for a subsequent SL positioning session by using a session ID corresponding to the second positioning session as the session ID for the subsequent SL positioning session.

In some embodiments, in SL positioning sessions, the second information includes the number of used SL positioning sessions, and a communication system assigns a session ID to the apparatus based on the number of used SL positioning sessions. In a case where an initialized second positioning session ends, a session ID of the second positioning session becomes idle. In some embodiments, the session ID in the idle state may be reassigned to another subsequent SL positioning session for use.

Two manners are provided for a receiver node to explicitly determine that the session ID of the second positioning session has become idle. At least one of these two manners may be employed.

### Manner 1

The transmitting module 1440 is configured to, upon completion of the second positioning session of initialized SL positioning sessions, transmit a notification message to the receiver node, wherein the notification message is used to notify a release of the second positioning session, or a release, invalidation, or idleness of the session ID of the second positioning session.

### Manner 2

In some embodiments, a first timer is set within the apparatus. A start time of the first timer is determined based on an end time of the second positioning session. Alternatively, a start or reset time of the first timer is determined based on a transmission time of a last message of the second positioning session.

The generating module 1410 is configured to, upon expiry of a first timer, generate a session ID for a subsequent SL positioning session by using a session ID corresponding to the second positioning session as the session ID for the subsequent SL positioning session.

In some embodiments, a timing duration of the timer may be predefined by a communication protocol, preconfigured by a network device, or determined by negotiation between terminal devices. For example, the timing duration of the timer is 0.5 ms.

It should be noted that, to enable the receiver node to explicitly determine that the session ID of the second positioning session has become idle, in a possible implementation, manner 1 and manner 2 may be executed simultaneously. Alternatively, manner 1 or manner 2 may be executed alone.

In some embodiments, in a case where the session ID corresponding to the second positioning session is used as a session ID for the subsequent SL positioning session, the count of the number of used SL positioning sessions is suspended from increasing.

In some embodiments, in a case where a duration for which the session ID of the second positioning session is in the idle state reaches a first duration, the session ID corresponding to the second positioning session is used as the session ID of the subsequent SL positioning session, wherein the first duration is the timing duration of the first timer.

In some embodiments, the apparatus further includes the resetting module 1430.

The resetting module 1430 is configured to reset the second information upon an increase in a value of the second information to a maximum value corresponding to N bits, wherein N is a positive integer.

The second information includes the number of used SL positioning sessions.

In some embodiments, the second information is represented by N bits. Upon an increase in a value of the second information to the maximum value represented by N bits, the second information may be reset and an accumulation process may restart. This approach may keep the value of the second information within a reasonable range.

For example, an 8-bit binary number is used to represent the second information. Initially, the value of the second information is 0. Each time the resetting module 1430 initializes a new SL positioning session, the value of the second information increases by 1. In a case where the second information increases to ‘11111111,’ i.e., reaching the maximum value 255 represented by 8 bits, the value of the second information is reset to 0 and the accumulation process restarts. The same 8 bits may be used cyclically to represent the number of SL positioning sessions, ensuring that the value of the second information is within a controllable range to guarantee data accuracy.

In view of the above, in the apparatus according to the embodiments of the present disclosure, in a case where the second information includes the number of SL positioning sessions that have been used within the apparatus, a timer may be set in the receiver node to indicate the end of the SL positioning session; or, upon an increase in a value of the second information to the maximum value corresponding to N bits, the second information is reset. This approach maintains the value of the second information within a reasonable range.

The acquiring module 1420 is configured to acquire second information, wherein the second information includes a timestamp based on absolute time.

In some embodiments, the second information includes a timestamp based on absolute time. The granularity of the timestamp may be predefined by a communication protocol, preconfigured by a network device, or determined by negotiation between terminals. For example, the timestamp is a second-level timestamp or a microsecond-level timestamp.

For example, the apparatus is a terminal device, and each time an SL positioning session is initialized, the acquiring module 1420 may acquire the timestamp based on the current absolute time as the second information. In different SL positioning sessions, the timestamp based on the absolute time varies each time an SL positioning session is initialized, resulting in different session IDs for the SL positioning sessions.

The generating module 1410 is configured to generate a third session ID for an SL positioning session, wherein the session ID is associated with first information and the second information.

Herein, the first information includes a unique ID of the apparatus.

In some embodiments, the first information refers to a unique ID of the apparatus and is used to form part of the session ID. In some embodiments, the first information may refer to a unique ID of a terminal device. In some embodiments, the first information may refer to unique IDs for a plurality of terminal devices. The plurality of terminal devices may be all terminal devices, all terminal devices in a specified area, or all terminal devices within a certain range of the initiator node.

For example, the initiator node is a terminal device, and the first information may refer to an IMEI of the terminal device. The IMEI is a unique ID used to identify the terminal device.

In some embodiments, the third session ID is acquired by concatenating the first information and the second information.

Concatenation refers to a process or operation of connecting two or more objects or information elements together to form a whole. In some embodiments, concatenation refers to combining the first information with the second information to form a session ID.

For example, the first information and the second information may be concatenated together via a string to form a new string as the third session ID of the SL positioning session.

In some embodiments, the third session ID may be generated by at least one of: concatenating the first information with the second information, or concatenating the second information with the first information.

In some embodiments, the third session ID is acquired by concatenating the first information and third information, wherein the third information is determined based on the second information and a first value, wherein the first value is a positive integer. In some embodiments, a value of the third information is equal to the sum of the first value and a value of the second information.

In some embodiments, the third information is acquired by adding the first value to the value of the second information, and the third session ID is acquired by concatenating the third information and the first information. The first value may be any positive integer. In an example, the first value is 2. In another example, the first value is 1. In some embodiments, the third session ID may be generated by at least one of: concatenating the first information with the third information, or concatenating the third information with the first information. It should be noted that the generating module 1410 may be implemented as an independent embodiment; the generating module 1410 and the acquiring module 1420 may be implemented as an embodiment; the generating module 1410 and the resetting module 1430 may be implemented as an embodiment; or the generating module 1410 and the transmitting module 1440 may be implemented as an embodiment, which is not elaborated herein.

It should be noted that, the operation of the apparatus according to the above embodiments in implementing its functions is illustrated solely based on the division of the functional modules. In practical applications, the functions may be assigned to different functional modules according to actual needs. That is, in terms of internal structure, a terminal device is divided into different functional modules to implement all or part of the functions as described above. In addition, the apparatus according to the above embodiments is based on the same concept as the method embodiments. For the specific implementation process, reference may be made to the method embodiments, which is not elaborated herein.

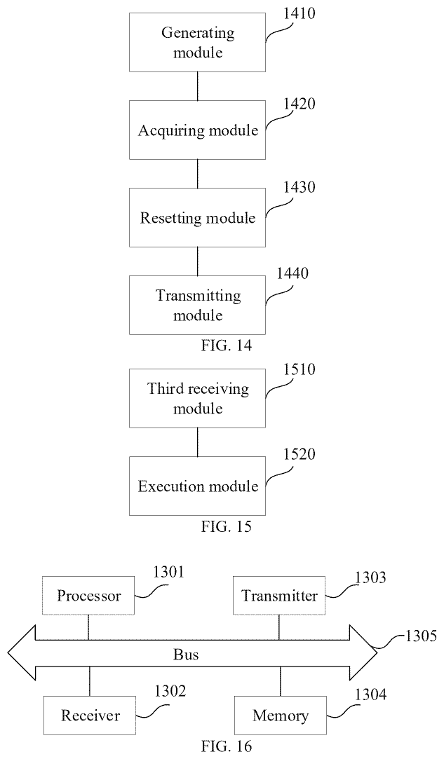

FIG. 15 is a structural block diagram of an apparatus for receiving a session ID of an SL positioning session according to some embodiments of the present disclosure. The apparatus has a function of implementing the method for receiving a session ID of an SL positioning session as described above. The apparatus may include: a third receiving module 1510 and an execution module 1520.

The third receiving module 1510 is configured to receive a third SLPP message, wherein the third SLPP message carries a session ID of a second positioning session.

The third SLPP message refers to a message that is used for transmitting and exchanging information and transmitted from an initiator node to the third receiving module 1510 under the SLPP protocol to support execution of an SL positioning process.

In some embodiments, the third SLPP message is a latest or last message in an SL positioning session.

In some embodiments, upon completion of a second positioning session in initialized SL positioning sessions, a session ID for a subsequent SL positioning session is generated by using a session ID corresponding to the second positioning session as the session ID for the subsequent SL positioning session. The initiator node transmits the third SLPP message to the third receiving module 1510, wherein the third SLPP message includes the session ID of the second positioning session that is released, invalidated, or set to an idle state.

The execution module 1520 is configured to, upon expiry of a second timer, release or invalidate the session ID of the second positioning session, or set the session ID of the second positioning session to an idle state.

Herein, a start time of the second timer is determined based on an end time of the second positioning session, or a start or reset time of the second timer is determined based on a reception time of the third SLPP message.

In some embodiments, the session ID of the second positioning session is associated with at least one of first information or second information, wherein the first information includes a unique ID of the initiator node, and the second information is distinctive information during initialization of different SL positioning sessions by the initiator node.

In some embodiments, the second timer associated with the second positioning session is set within the apparatus. In a case where the third receiving module 1510 receives a notification message from the initiator node, wherein the notification message is used to indicate the end of the second positioning session, the start time of the second timer may be determined based on the end time of the second positioning session; or the start or reset time of the second timer is determined based on the reception time of the third SLPP message. The second timer is reset upon reception of messages related to the second positioning session. Upon reception of the notification message or expiry of the second timer, the second timer triggers the apparatus to set the session ID of the second positioning session to be invalid or idle. In some embodiments, a timing duration of the timer may be predefined by a communication protocol, preconfigured by a network device, or determined by negotiation between terminal devices. For example, the timing duration of the timer is 0.5 ms.

In view of the above, in the apparatus according to the embodiments of the present disclosure, the third receiving module 1510 receives a third SLPP message carrying a session ID of a second positioning session. Upon expiry of a second timer, the apparatus releases or invalidates the session ID of the second positioning session, or sets the session ID of the second positioning session to an idle state. This approach ensures that the apparatus is aware of the state of the session ID being released or idle, thereby improving the efficiency and accuracy of the communication system.

FIG. 16 is a structural block diagram of a terminal device according to an embodiment of the present disclosure. The terminal device may be configured to perform the method for transmitting and generating a session ID of an SL positioning session according to the embodiments as described above. The terminal device may include: a processor 1301, a receiver 1302, a transmitter 1303, a memory 1304, and a bus 1305.

The processor 1301 includes one or more processing cores. The processor 1301 executes various functional applications and performs information processing by running software programs and modules.

The receiver 1302 and the transmitter 1303 may be implemented as a transceiver, which may be a communication chip.

The memory 1304 is connected to the processor 1301 via the bus 1305. In some embodiments, the processor 1301 may be implemented as a first IC chip, and the processor 1301 and the memory 1304 may be jointly implemented as a second IC chip. The first chip or the second chip may be an application-specific integrated circuit (ASIC) chip.

The memory 1304 may be configured to store at least one computer program, and the processor 1301 is configured to execute the at least one computer program to perform steps executed by the communication system in the method embodiments as described above.

In addition, the memory 1304 may be implemented by any type of volatile or non-volatile storage device or a combination thereof. The volatile or non-volatile storage device includes, but are not limited to: a random-access memory (RAM), a read-only memory (ROM), an erasable programmable ROM (EPROM), an electrically EPROM (EEPROM), a flash memory or other solid-state storage technologies, a compact disc ROM (CD-ROM), a high-density digital video disc (DVD), or other optical storage, a tape cartridge, a magnetic tape, a magnetic disk storage, or other magnetic storage devices.

Some embodiments of the present disclosure further provide a chip. The chip includes a programmable logic circuitry and/or one or more programs, wherein the chip, when running on a terminal device, is configured to perform the method for receiving, transmitting, and generating a session ID as described above.

Some embodiments of the present disclosure further provide a computer-readable storage medium. The computer-readable storage medium stores one or more computer programs. The one or more computer programs, when loaded and run by a processor, cause the processor to perform the method for receiving, transmitting, and generating a session ID as described above.

Some embodiments of the present disclosure further provide a computer program product. The computer program product, when running on a processor, causes the processor to perform the method for receiving, transmitting, and generating a session ID as described above.

It should be understood that the term “plurality” as used herein refers to “two or more.” The term “and/or” as used herein describes an association relationship of associated objects, indicating that three relationships may exist. For example, the phrase “A and/or B” may indicate (A), (A and B), and (B). In addition, the character “/” as used herein generally indicates that associated objects preceding and following the character are in an “or” relationship. In addition, the step numbers described herein are provided merely as examples to illustrate one possible sequence of execution among the steps. In other embodiments, these steps may be performed out of sequence, such as executing two steps with different numbers simultaneously, or executing two steps with different numbers in an order opposite to that illustrated in the figures, which is not limited in the embodiments of the present application.

Described above are merely some exemplary embodiments of the present disclosure and are not intended to limit the present disclosure. Any modification, equivalent replacement, improvement, or the like made within the spirit and principle of the present disclosure shall be encompassed in the protection scope of the present disclosure.

1. A method for receiving a session identifier (ID) of a sidelink (SL) positioning session, performed by a receiver node, the method comprising:
receiving a first SL positioning protocol (SLPP) message, wherein the first SLPP message carries a first session ID; and
transmitting a first message in a case where the first session ID is identical to any stored session ID, wherein the first message is used to request or direct a change to the first session ID;
wherein the first session ID is used to identify a first positioning session to which the first SLPP message belongs.

2. The method according to claim 1, wherein the first SLPP message carries indication information, used to indicate that the first SLPP message is a leading or an initial message of the first positioning session.

3. The method according to claim 1, further comprising:
receiving a second SLPP message, wherein the second SLPP message carries a second session ID, wherein the second session ID is a changed session ID for the first positioning session.

4. The method according to claim 3, wherein the second SLPP message carries indication information, used to indicate that the second SLPP message is a leading or an initial message of the first positioning session.

5. The method according to claim 1, wherein the receiver node is removed from the first positioning session by an initiator node upon the initiator node receiving the first message.

6. A method for generating a session identifier (ID) of a sidelink (SL) positioning session, performed by an initiator node, the method comprising:
generating a third session ID for the SL positioning session, wherein the third session ID is associated with least one of first information or second information;
wherein the first information comprises a unique ID of the initiator node, and the second information is distinctive information during initialization of different SL positioning sessions by the initiator node.

7. The method according to claim 6, wherein the second information comprises a number of SL positioning sessions that have been used within the initiator node.

8. The method according to claim 6, wherein the second information comprises a timestamp based on absolute time.

9. The method according to claim 7, wherein the third session ID is acquired by concatenating:
the first information and the second information; or
the first information and third information, wherein the third information is determined based on the second information and a first value, the first value being a positive integer.

10. The method according to claim 6, wherein the second information comprises a maximum value of session IDs of SL positioning sessions that have been used within the initiator node.

11. The method according to claim 10, wherein the third session ID is determined based on a second value and the maximum value of the session IDs, the second value being a positive integer.

12. The method according to claim 7, further comprising:
upon completion of a second positioning session in initialized SL positioning sessions, generating a session ID for a subsequent SL positioning session by using a session ID corresponding to the second positioning session as the session ID for the subsequent SL positioning session.

13. The method according to claim 12, wherein generating the session ID for the subsequent SL positioning session by using the session ID corresponding to the second positioning session as the session ID for the subsequent SL positioning session comprises:
upon expiry of a first timer, generating the session ID for the subsequent SL positioning session by using the session ID corresponding to the second positioning session as the session ID for the subsequent SL positioning session;
wherein:
a start time of the first timer is determined based on an end time of the second positioning session; or
a start or reset time of the first timer is determined based on a transmission time of a last message of the second positioning session.

14. The method according to claim 13, wherein a timing duration of the first timer is specified by a communication protocol, configured by a network device, or preconfigured by a terminal device.

15. The method according to claim 7, further comprising:
upon completion of a second positioning session of the SL positioning sessions that have been used, transmitting a notification message;
wherein the notification message is used to notify:
a release of the second positioning session; or
a release, invalidation, or idleness of a session ID of the second positioning session.

16. The method according to claim 7, further comprising: upon an increase in a value of the second information to a maximum value corresponding to N bits, resetting the second information, wherein N is a positive integer.

17. A terminal device, comprising:
a memory, configured to store at least one computer program; and
a processor, configured to execute the at least one computer program to:
receive a third sidelink positioning protocol (SLPP) message, wherein the third SLPP message carries a session identifier (ID) of a second positioning session; and
upon expiry of a second timer, release or invalidate the session ID of the second positioning session, or set the session ID of the second positioning session to an idle state;
wherein:
a start time of the second timer is determined based on an end time of the second positioning session; or
a start or reset time of the second timer is determined based on a reception time of the third SLPP message.

18. The terminal device according to claim 17, wherein a timing duration of the second timer is specified by a communication protocol, configured by a network device, or preconfigured by the terminal device.

19. The terminal device according to claim 17, wherein the processor is further configured to execute the at least one computer program to: receive a notification message, wherein the notification message is used to indicate an end of the second positioning session.

20. The terminal device according to claim 17, wherein the session ID of the second positioning session is associated with at least one of first information or second information, wherein the first information comprises a unique ID of an initiator node, and the second information is distinctive information during initialization of different SL positioning sessions by the initiator node.
